(19) United States
(12) Patent Application Publication
(10) Pub. No.: US 2004/0246735 A1
(43) Pub. Date: Dec. 9, 2004

(54) DRAGON ALUMINUM ATX COMPUTER CHASSIS

(75) Inventor: EDWARD HUANG, WALNUT, CA (US)

Correspondence Address: MGE COMPANY, 20621 E. VALLEY BLVD. #A, WALNUT, CA, 91789, US

(73) Assignee: Mr. EDWARD HUANG, WALNUT, CA (US)

(21) Appl. No.: 10/711,073

(22) Filed: Aug. 20, 2004

(51) Int. Cl. A47B 97/00; F21S 4/00

(52) U.S. Cl. 362/487; 312/223.5; 362/806

(57) ABSTRACT

The Dragon Aluminum ATX Computer Chassis enables the user to implement their computer components and maintain their stability with high tech electronic components such as the Dragon LCD display. Its features does not end there, Dragon's exterior shell was designed with an “Out of the Box” concept, in which the MGE core developer invented the term and utilized this term as the basis of the Dragon ATX Aluminum Computer Chassis.

### SUMMARY OF INVENTION

The DRAGON Aluminum ATX Computer Chassis is composed of pure 100% aluminum alloy and hardened plastics and electronics. Its main design goal is to give the owner of the product a sense of quality and unparallel craftsmanship that only the DRAGON can deliver. Its chassis is based around a “Trouble Free” design concept in which each edge is rounded free from installation hazards and high-end reliable power supply that exemplify what every computer chassis should come with. Its “Installation Made Easy” concept is based around the ease of installing the owners own computer components with a simple snap and click method. The DRAGON ATX Computer Chassis personifies what the leading computer industry is leading to. A computer chassis “trouble free” for all to utilize with minimal effort.

### BRIEF DESCRIPTION OF DRAWINGS

FIG. 1.1—Multiple LED Lighted Door Part 1 displays the logo in a acrylic material that is lighted by the use of the LED light(s). This part may be lighted at will by the switch connected to the actual working part of the acrylic part. The amount of LED lights used may contain anywhere from 1 to 16 LED lights. The acrylic part itself is high gloss coated in which display a clear smooth and reflected surface.

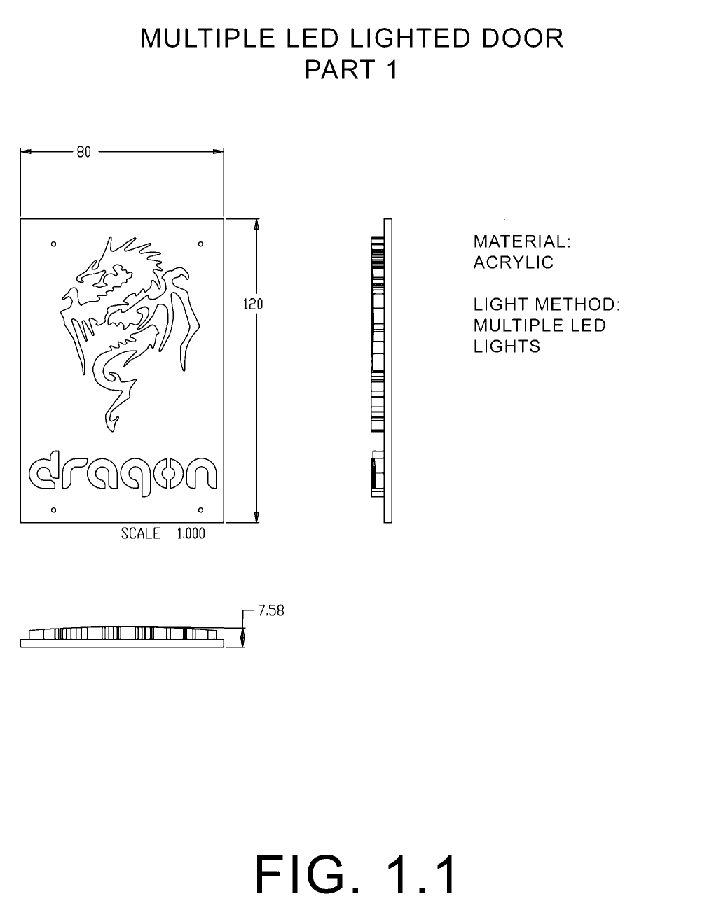

FIG. 1.2—Multiple LED Lighted Door Part 2 displays the outer door part that holds part 1 (FIG. 1.1) within itself.

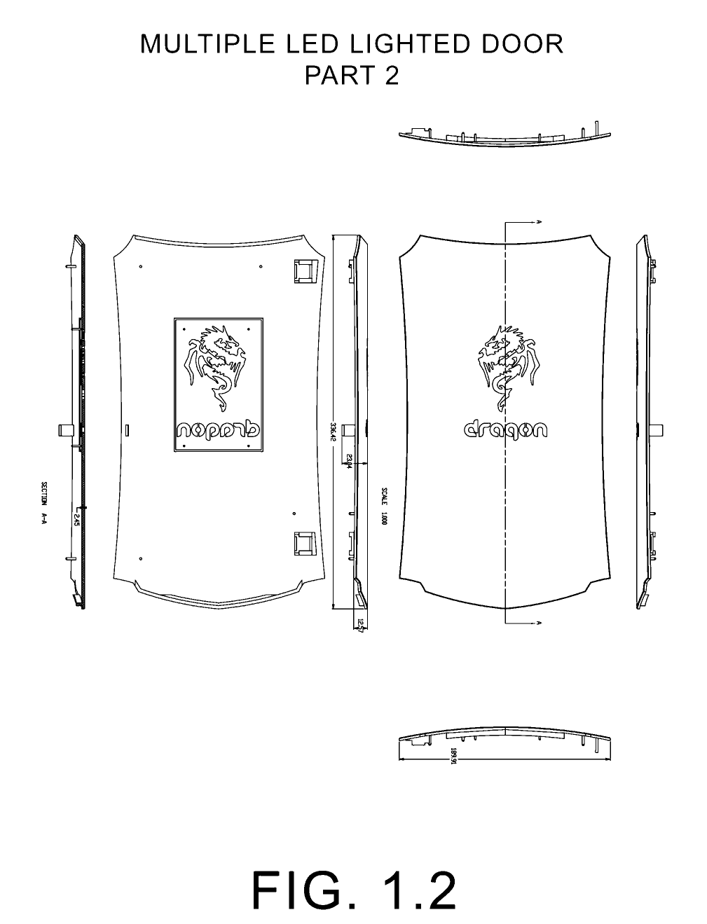

FIG. 2.1—Re-Inforced Single Handle with I/O Port Hub Part 1 displays the handle and part I/O hub in actual form for reference of FIGS. 2.2, 2.3, 2.4, 2.5, 2.6, 2.7, 2.8.

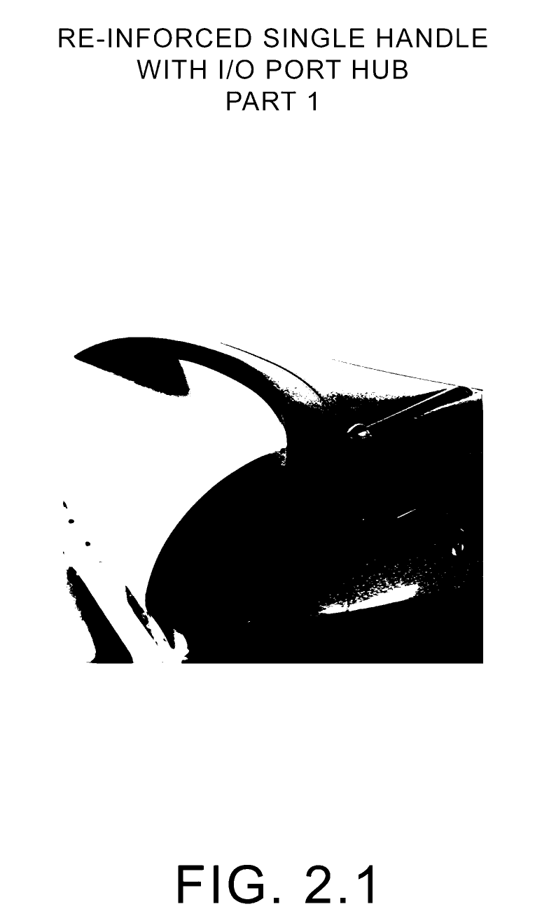

FIG. 2.2—Re-Inforced Single Handle with I/O Port Hub Part 2 (Door Flap) display the actual door method in covering the I/O Port Hub that consists of two USB 2.0 ports, one IEEE 1394 port, Speaker and Mic ports.

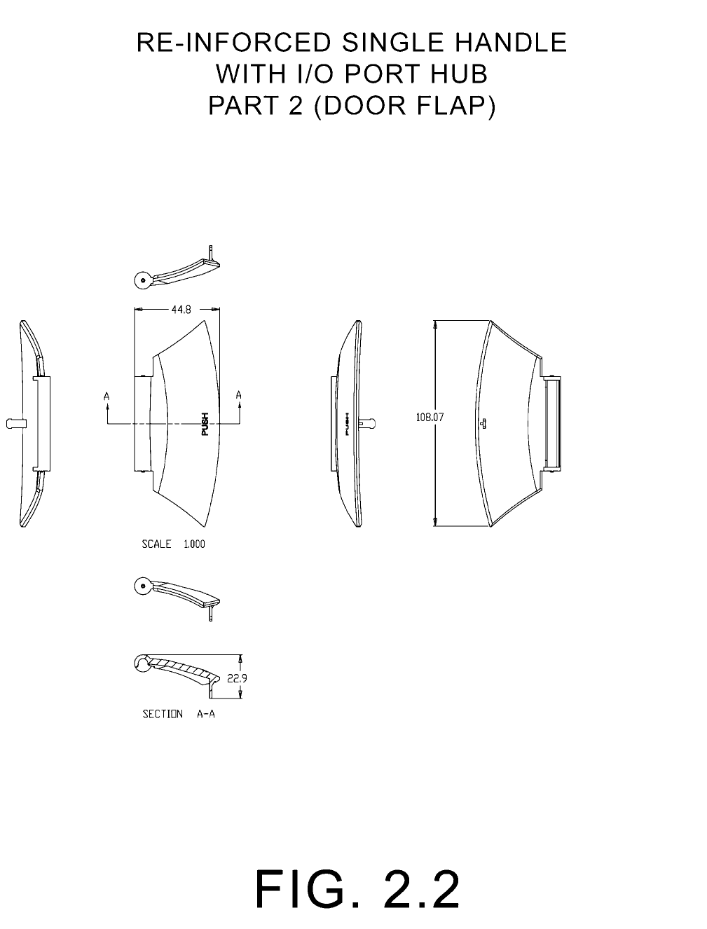

FIG. 2.3—Re-Inforced Single Handle with I/O Port Hub Part 3 (Exterior Handle Subpart 1) displays the first part in creating the top portion of the handle.

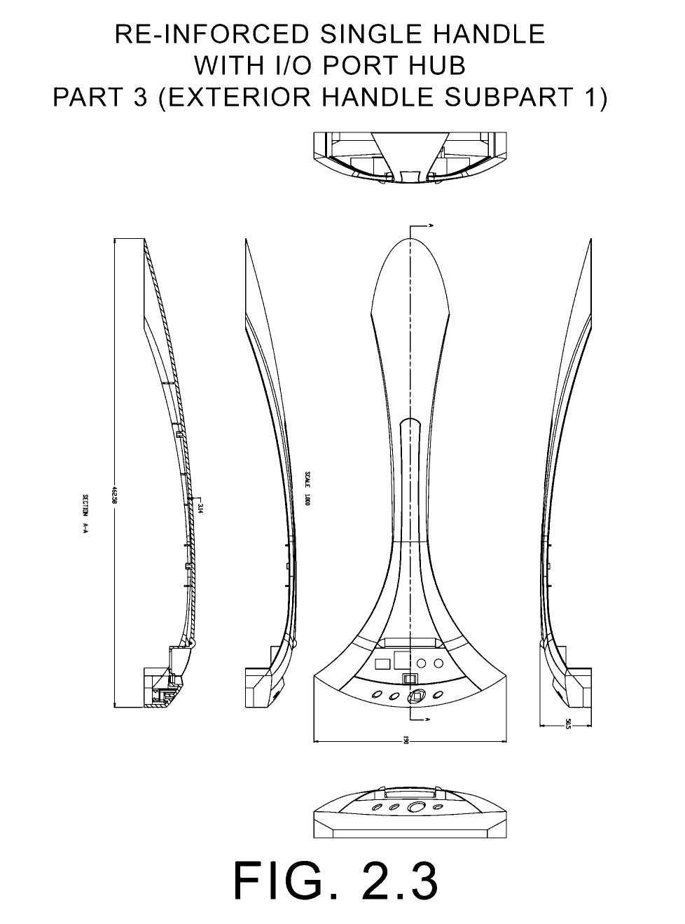

FIG. 2.4—Re-Inforced Single Handle with I/O Port Hub Part 4 (Exterior Handle Subpart 2) displays the second part in creating the bottom portion of the handle.

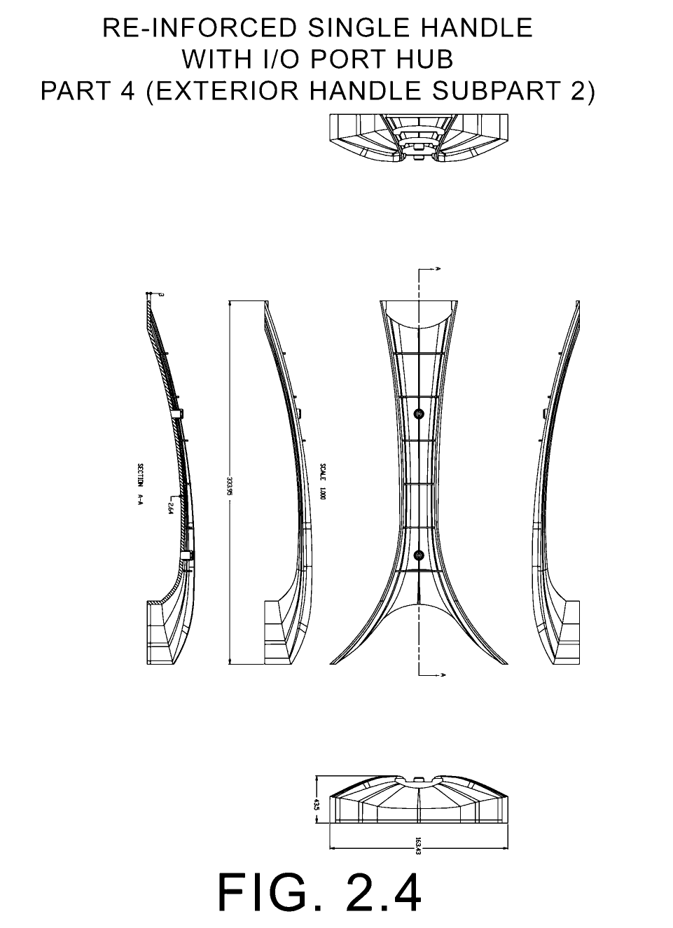

FIG. 2.5—Re-Inforced Single Handle with I/O Port Hub Part 5 (Interior Re-Inforced Metal Handle Subpart 1) displays the inner portion of the handle that can retain the full weight of a computer system.

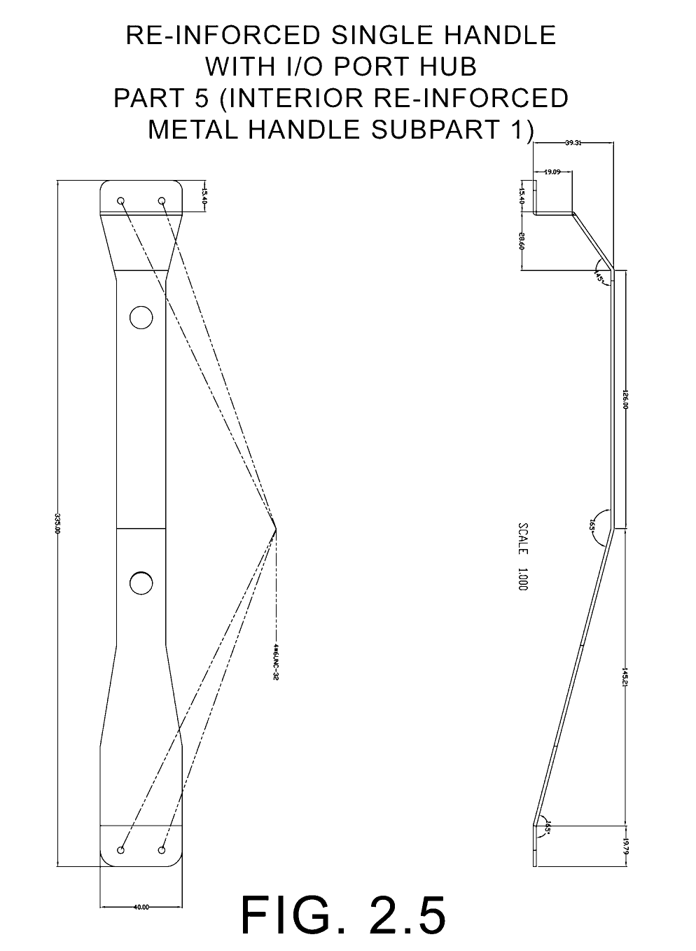

FIG. 2.6—Re-Inforced Single Handle with I/O Port Hub Part 6 (Interior Aluminum Plate Re-Inforced Subpart 2) displays the second part of FIG. 2.5 which is the base of the handle that holds the entire handle and I/O port hub intact.

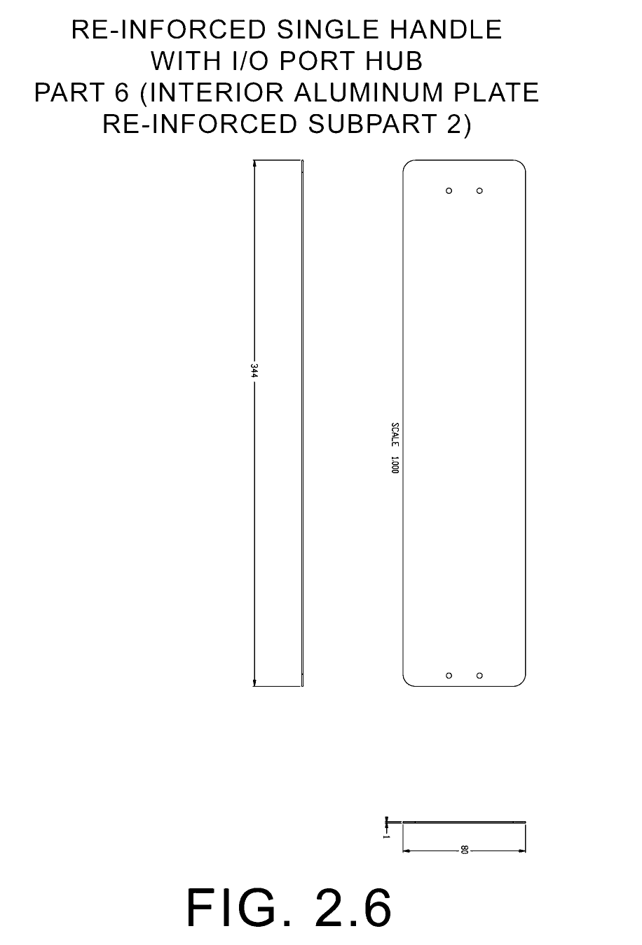

FIG. 2.7—Re-Inforced Single Handle with I/O Port Hub Part 7 (Acrylic Harddrive and Power Indicator Lights) displays the actual acrylic part in which two led lights are used to display the current harddrive cycles and power on/off.

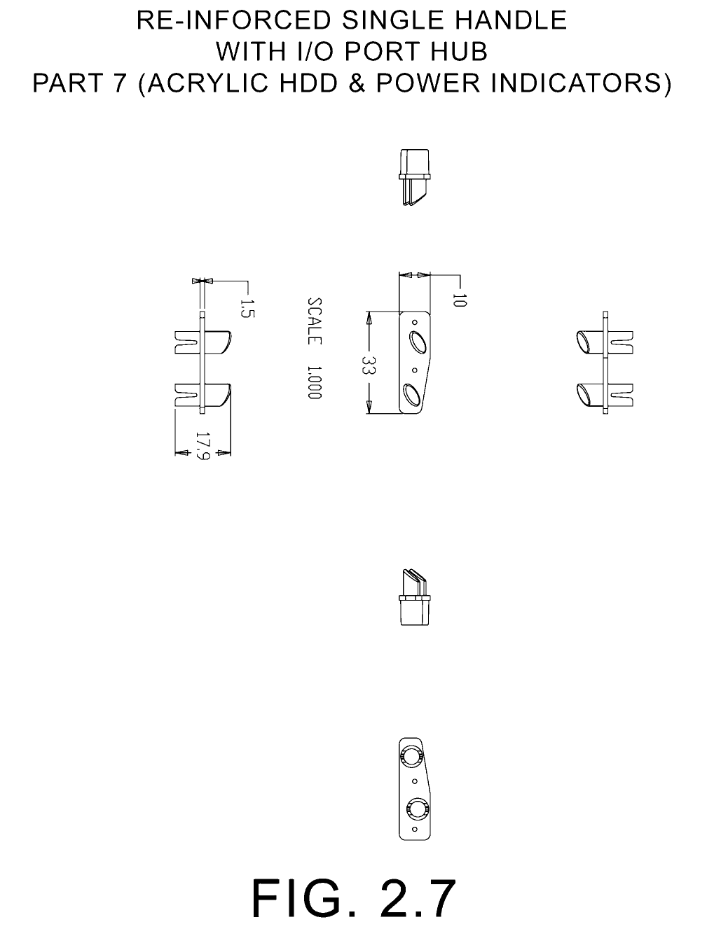

FIG. 2.8—Re-Inforced Single Handle with I/O Port Hub Part 8 (USB Bridge) displays the internal housing part of the I/O port hub that is internally mounted to the actual aluminum chassis and retains the two USB 2.0 ports, one IEEE 1394 port, speaker and mic ports.

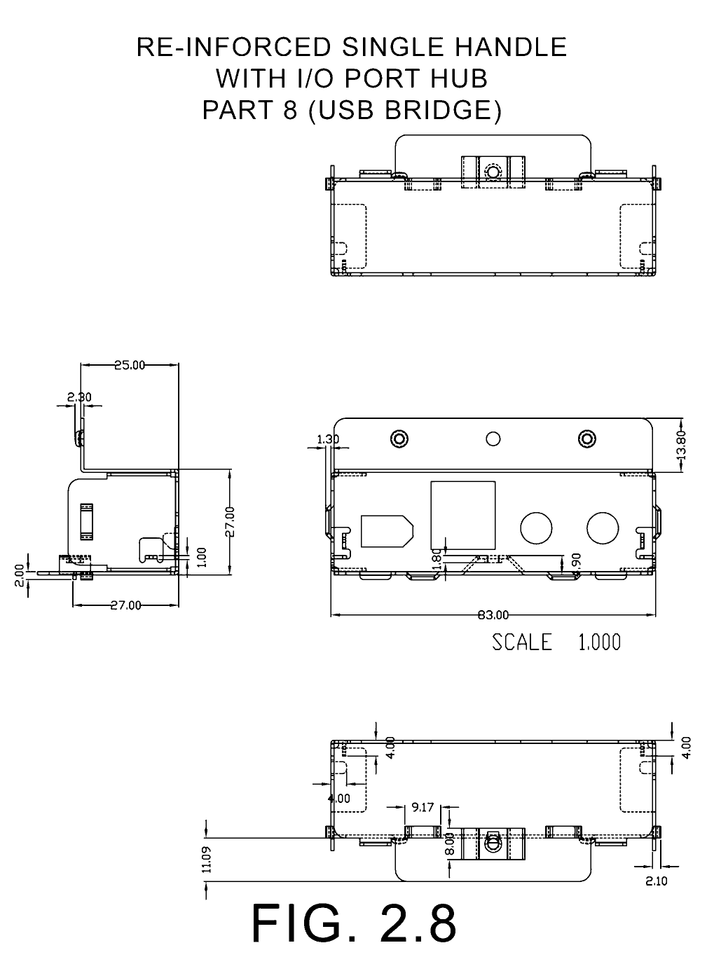

FIG. 3.1—Front Panel Dragon Design Part 1 (Right Top Front Panel Grill Subpart 1) displays the top portion of the front grill located on the right side of the computer chassis.

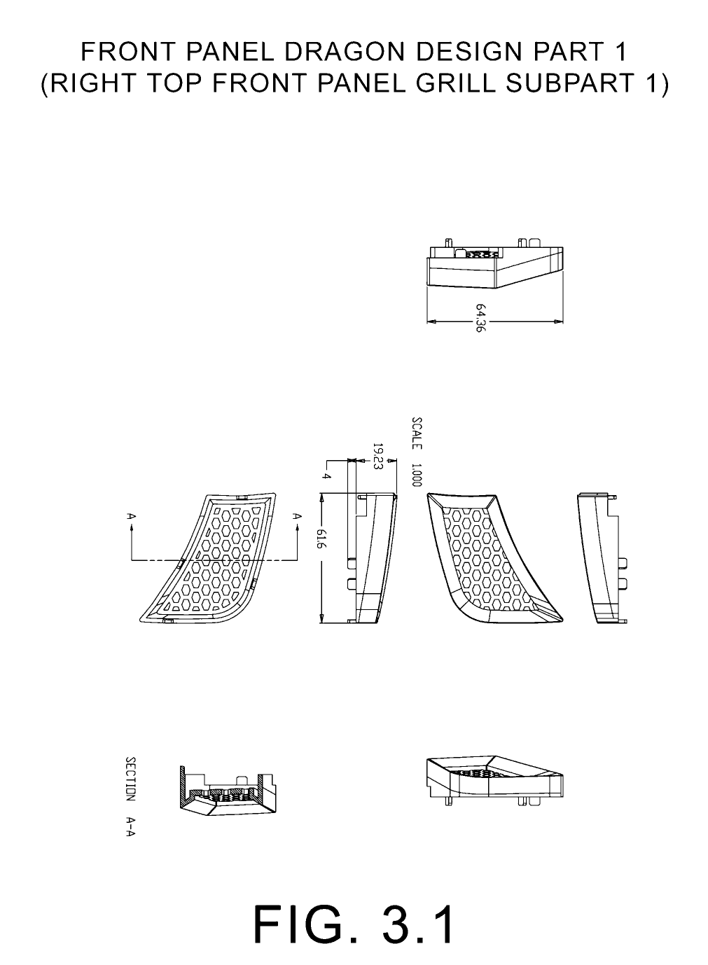

FIG. 3.2—Front Panel Dragon Design Part 2 (Right Top Front Panel Grill Subpart 2) displays the bottom portion of the front grill located on the right side of the computer chassis.

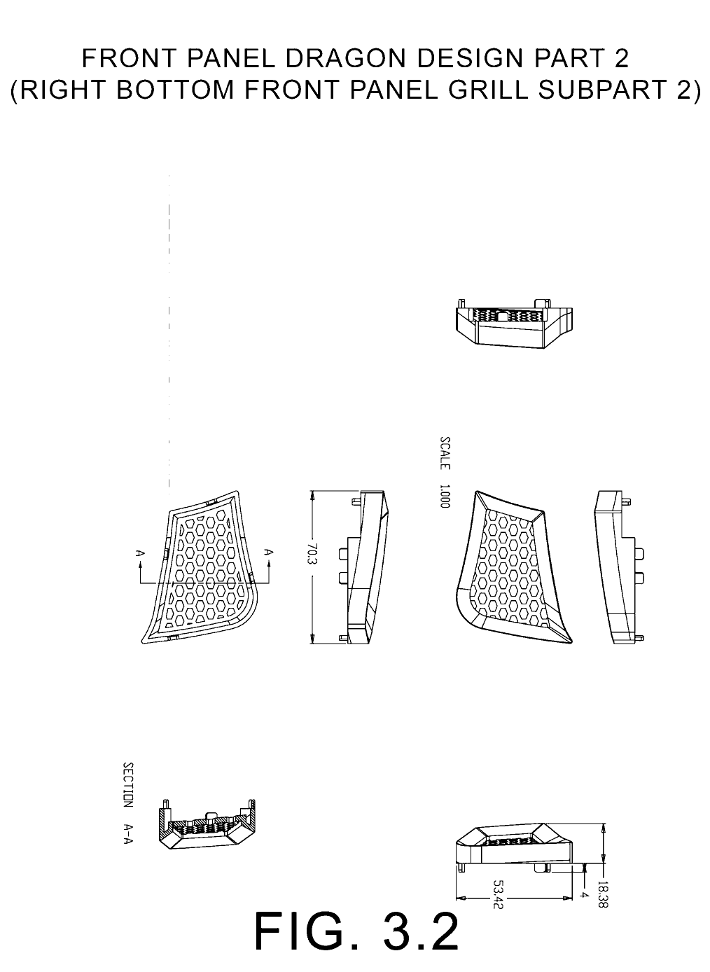

FIG. 3.3—Front Panel Dragon Design Part 3 (Left Top Front Panel Grill Subpart 1) displays the top portion of the front grill located on the left side of the computer chassis.

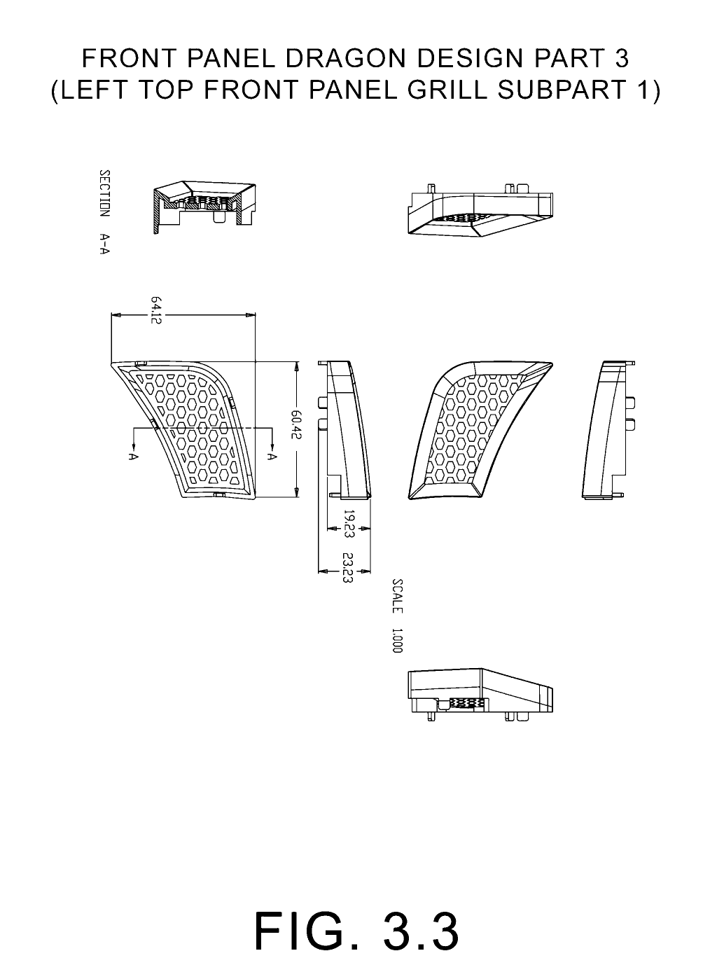

FIG. 3.4—Front Panel Dragon Design Part 4 (Left Top Front Panel Grill Subpart 2) displays the bottom portion of the front grill located on the left side of the computer chassis.

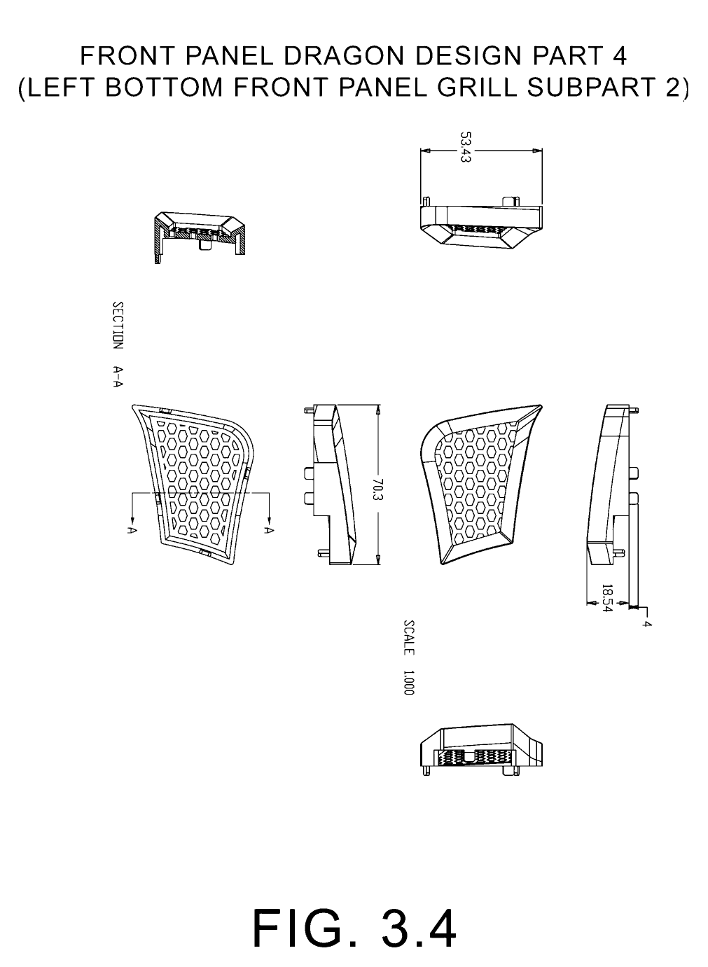

FIG. 3.5—Front Panel Dragon Design Part 5 (Main Front Panel, Subpart 1) displays the main portion of the front panel design.

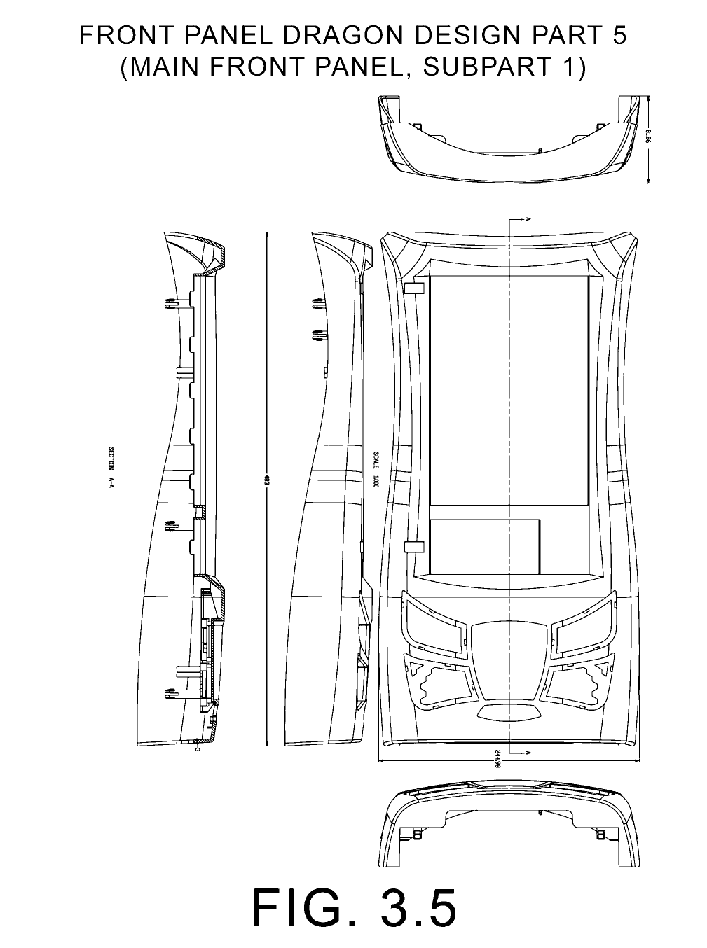

FIG. 3.6—Front Panel Dragon Design Part 6 (Top Panel Ribbon) displays the ribbon or crown in which is used to hold down the handle and front panel.

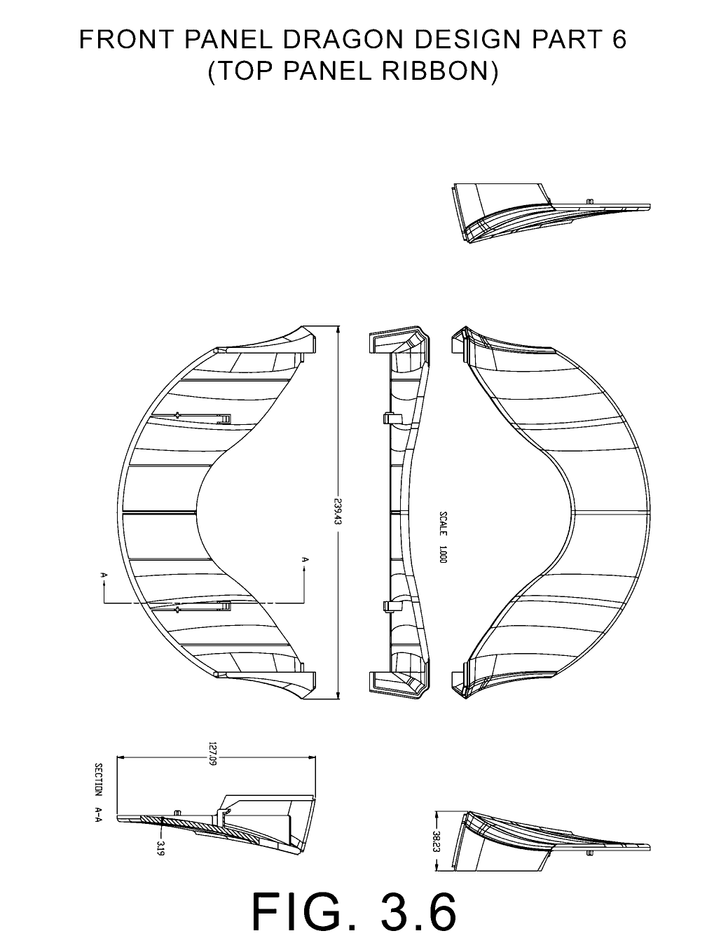

FIG. 3.7—Front Panel Dragon Design Part 7 (Right Panel Ribbon) displays the right side plastic ribbon portion which goes attached to the right side panel and completes the entire front panel design with “Out of the Box” implementation.

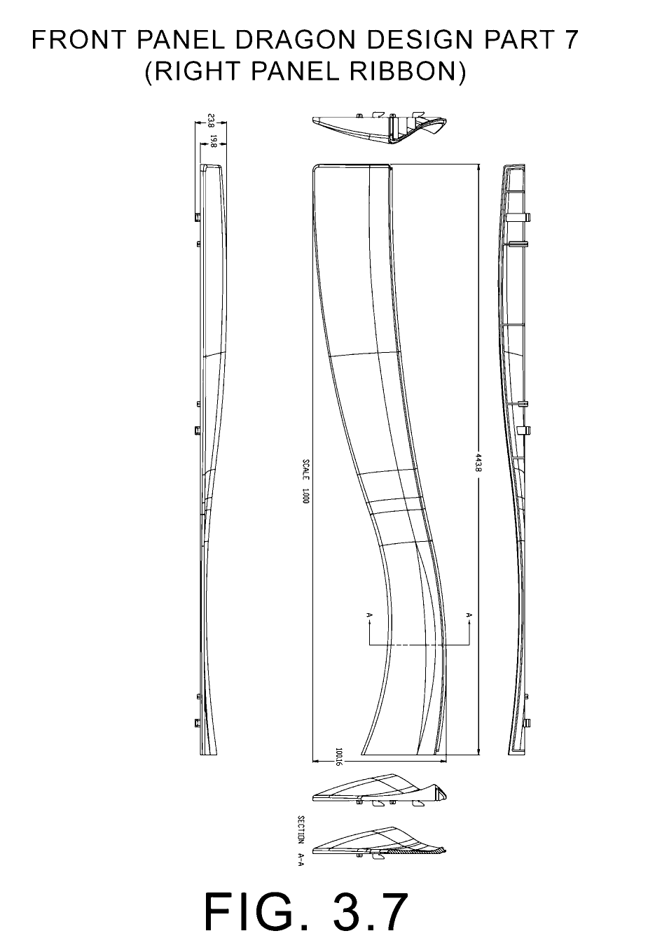

FIG. 3.8—Front Panel Dragon Design Part 8 (Left Panel Ribbon) displays the left side plastic ribbon portion which goes attached to the left side panel and completes the entire front panel design with “Out of the Box” implementation.

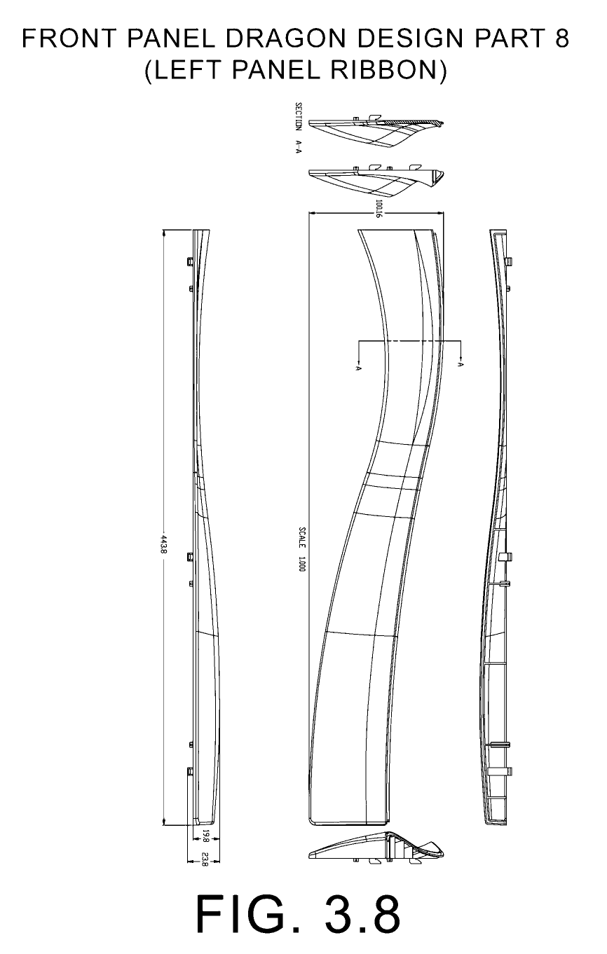

FIG. 4.1—3D Static Guard (Wire Management) displays the rear plastic portion in which aids the need for wire management when plugging in all necessary cables to the computer system. The term 3D Static Guard is used to best describe the “Out of the Box” concept for rear end computer chassis design.

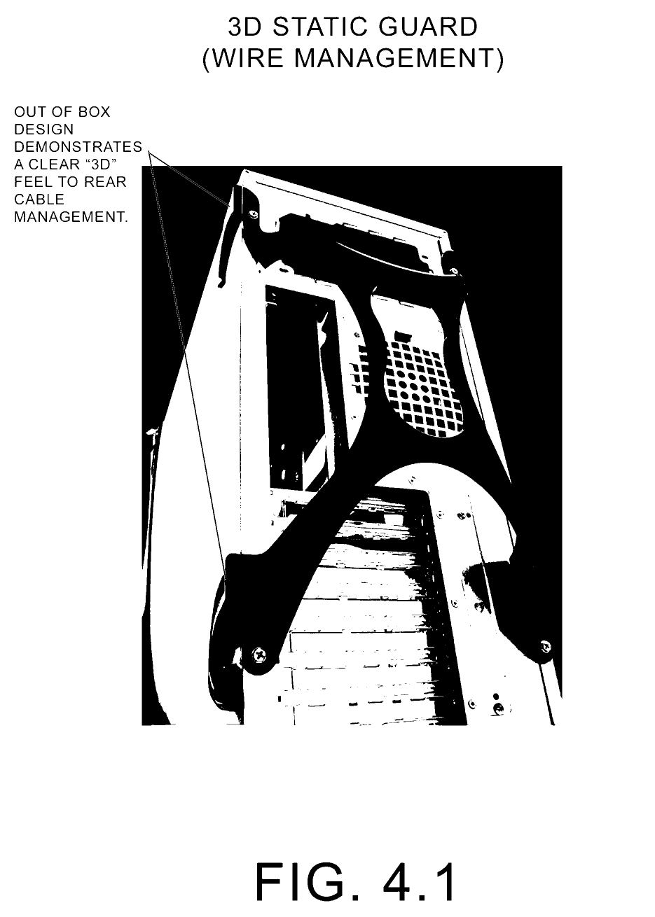

FIG. 5.1—Dragon LCD Display's the LCD portion itself with its functionality of what the component will do.

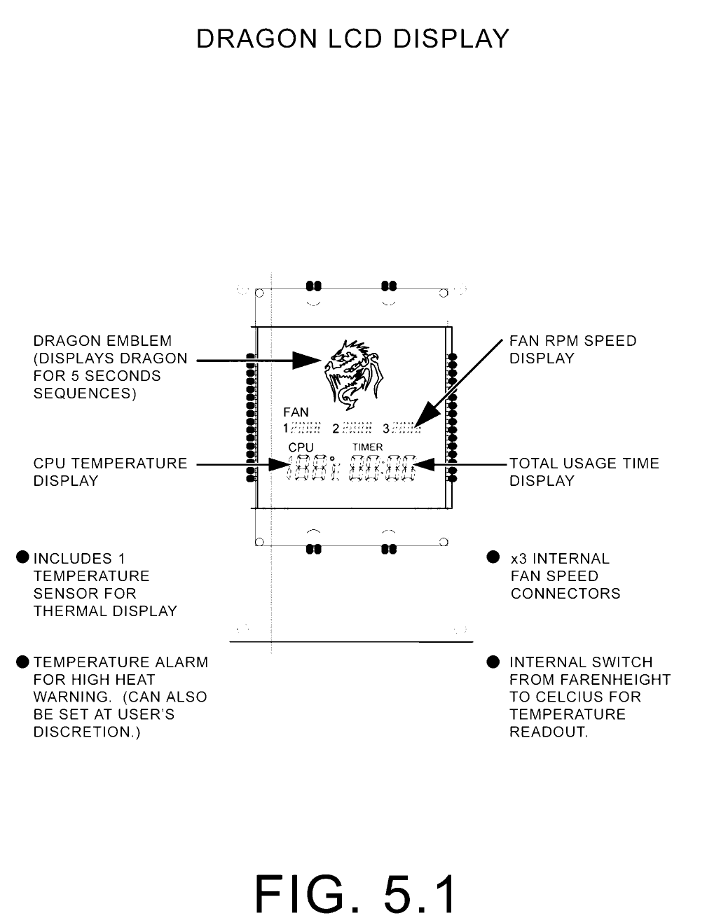

### DETAILED DESCRIPTION

The DRAGON Aluminum ATX Computer Chassis is composed of pure 100% aluminum alloy and hardened plastics and electronics. Its main design goal is to give the owner of the product a sense of quality and unparallel craftsmanship that only the DRAGON can deliver. It's chassis is based around a “Trouble Free” design concept in which each edge is rounded out free from installation cuts and a high-end reliable power supply that exemplify what every computer chassis should come with. Its “Installation Made Easy” concept is based around the ease of installing the owners own computer components with a simple snap and click method. The DRAGON ATX Computer Chassis personifies what the leading computer industry is leading to. A computer chassis “trouble free” for all to utilize with minimal effort.

The Dragon's chassis provides five 5.25″ inch drive bays, three internal 3.5″ inch drive bays, and two external 3.5″ inch drive bays—all of which retain the end-users computer components. Each internal 3.5″ inch bay has the implemented “Installation Made Easy” concept in which each drive bay is capable of delivering an unsurpassed ease of installation method. Internal components are pivoted on a drawer method where the component slides in much like a cabinet would within a drawer. The Dragons main objective is to provide unparallel aesthetics and concepts that no other case manufacture can offer such as the use of a “re-inforced single handle” which goes beyond the traditional design of computer handles. The Dragon's handle design implements a new higher standard by providing an internal metal handle within the plastic housing, which is then mounted onto the top panel of the case and bolted onto an internal aluminum plate right underneath the top aluminum panel. This re-inforced method was designed by MGE Company to produce a sturdy lightweight design that is tested to hold well up to 100 lbs.

Dragon's LCD panel display goes beyond the traditional method of an ordinary temperature display. It functions enable the user to read the rotation per minute or RPM of 3 internal fans that are connected to the internal part of the LCD display. Second, it also displays the temperature setting of one specific location designated by the user. Third, the timer records and displays the total usage time the computer system has been on. Fourth, the Dragon logo is digitally created and lighted within the LCD display that shows in a five second sequential format. Fifth, the internal back-end of the LCD display has a button that can enable the user to view the internal temperature in fahrenheit or celcius degrees. Sixth, the Dragon's LCD display warns the user of any high heat output associated with the placement of the temperature sensor—this alarm can also be set to any degree of which the user may determine and set the alarm accordingly to the source of which he/she would like to monitor. The Dragon's features alone does not end with just the notations above, it also offers a 3D Static Guard for wire management when setting up and organizing the computer system, a ultra violet blue acrylic window with the Dragon symbol laser sketched onto the acrylic itself to illuminate when an internal light source is available within the computer system. Other features include a four grill front panel airflow system that is capable of cooling down the user's storage devices such as internal hard-drive(s). The Dragon Aluminum ATX Computer Chassis also offers “trouble free” PCI expansion slots, “trouble free” 92 mm and 80 mm fan clips, “trouble free” dust fan filters that catches dust prior to entering the internal computer chassis. In conclusion, the Dragon offers a light weight, fully expandable, aluminum chassis that is truly “trouble free.”

1. Multiple LED Lighted Door Part 1 displays the logo in a acrylic material that is lighted by the use of the LED light(s). This part may be lighted at will by the switch connected to the actual working part of the acrylic part. The amount of LED lights used may contain anywhere from 1 to 16 LED lights. The acrylic part itself is high gloss coated in which display a clear smooth and reflected surface.

2. Re-Inforced Single Handle with an internal I/O Port Hub that holds and aids in the convenient centralized location of two USB 2.0 ports, one IEEE 1394 port, one speaker port, and one mic input port. The handle itself consists of two four parts: (1) top shell of the handle, (2) bottom shell of the handle, (3) internal reinforced metal handle within the shell, and (4) the internal chassis aluminum plate that binds the shell and internal metal handle to the actual top panel of the computer chassis.

3. Four part front panel grill provides an abundant source of airflow directly to the internal 3.5″ inch drive bays. This cooling method will allow a better flow and performance of data storage and search on the hard-drive component(s).

4. 3D Static Guard (Wire Management) displays the rear plastic portion in which aids the need for wire management when plugging in all necessary cables to the computer system. The term 3D Static Guard is used to best describe the “Out of the Box” concept for rear end computer chassis design.

5. Dragon's LCD panel display goes beyond the traditional method of just temperature display. It functions enable the user to read the rotation per minute or RPM of 3 internal fans that are connected to the internal part of the LCD display. Second, it also displays the temperature setting of one specific location designated by the user. Third, the timer itself records and displays the total usage time the computer system has been left on. Fourth, the Dragon logo itself is digitally created and lighted within the LCD display that shows itself in a five second sequential format. Fifth, the internal back-end of the LCD display has a button that can enable the user to view the internal temperature in a fahrenheit or celcius degree format. Sixth, the Dragon's LCD display also warns the user of any high heat output associated with the placement of the temperature sensor. This alarm may be set to any degree the user desires—dependent of the source of which he/she would like to monitor.

6. Dragon's front panel design implements the “out of the box” concept designed by the MGE product developer. This particular method is applied with designing a computer chassis that goes well beyond the traditional box method of computer chassis and re-invents itself as a fully detailed shape that extends beyond the box constraint in all facets of the actual aluminum case.
